(19) United States
(12) Patent Application Publication
(10) Pub. No.: US 2020/0396394 A1
(43) Pub. Date: Dec. 17, 2020

(54) METHOD FOR GENERATING AN OUTPUT IMAGE SHOWING A MOTOR VEHICLE AND AN ENVIRONMENTAL REGION OF THE MOTOR VEHICLE IN A PREDETERMINED TARGET VIEW, CAMERA SYSTEM AS WELL AS MOTOR VEHICLE

(71) Applicant: Connaught Electronics Ltd., Tuam, County Galway (IE)

(72) Inventors: Vladimir Zlokolica, Tuam (IE); Mark Patrick Griffin, Tuam (IE); Brian Michael Thomas Deegan, Tuam (IE); Barry Dever, Tuam (IE); John Maher, Tuam (IE)

(73) Assignee: Connaught Electronics Ltd., Tuam, County Galway (IE)

(21) Appl. No.: 16/753,974

(22) PCT Filed: Oct. 10, 2018
(86) PCT No.: PCT/EP2018/077588

§ 371 Date: Apr. 6, 2020

(30) Foreign Application Priority Data
Oct. 10, 2017 (DE) 10 2017 123 452.7

(51) Int. Cl. H04N 5/265; H04N 5/247; G06T 5/20; G06T 5/00; G06T 5/50; G06T 5/10; B60R 11/04

(52) U.S. Cl. CPC H04N 5/265; H04N 5/247; G06T 5/20; G06T 5/002; G06T 5/50; G06T 5/003; B60R 1/00; B60R 11/04; G06T 2207/20064; G06T 2207/20221; G06T 2207/30252; B60R 2300/303; B60R 2300/105; G06T 5/10

(57) ABSTRACT

The invention relates to a method for generating an output image with a predefined target view showing a motor vehicle (1) and an environmental region (4) of the motor vehicle (1) based on at least partially overlapping raw images (RC1, RC2, RC3, RC4) captured by at least two vehicle-side cameras (5a, 5b, 5c, 5d), comprising the steps of:
specifying respective camera-specific pixel density maps (PDM1a, PDM1b, PDM2a, PDM2b), which each describe an image-region dependent distribution of a number of pixels of the raw image (R1 to R4) captured by the associated camera (5a to 5d) contributing for the generation of the output image,
spatially adaptive filtering of the raw images (RC1 to RC4) based on the pixel density map (PDM1a to PDM2b) specific to the associated camera (5a to 5d), which indicates an image region-dependent extent of the filtering,
identifying mutually corresponding image areas (B1a, B1b, B2a, B2b, B3a, B3b, B4a, B4b) in the at least partially overlapping raw images (RC1 to RC4) of the at least two cameras (5a to 5d),
spatially adaptive filtering of the image area (B1a to B4b) of the raw image (RC1 to RC4) of the one camera (5a to 5d) based on the pixel density map (PDM1a to PDM2b) specific to the respective other camera (5a to 5d) for reducing a sharpness difference between the corresponding image areas (B1a to B4b),
remapping the filtered raw images (RC1 to RC4) to an image surface corresponding to the target view for generating remapped filtered raw images (R1, R2, R3, R4),
generating the output image by combining the remapped filtered raw images (R1 to R4).

The invention moreover relates to a camera system (3) as well as to a motor vehicle (1).

The invention relates to a method for generating an output image showing a motor vehicle and an environmental region of the motor vehicle in a predetermined target view based on at least partially overlapping raw images captured by at least two vehicle-side cameras. In addition, the invention relates to a camera system for a motor vehicle as well as to a motor vehicle.

It is already known from the prior art to monitor an environmental region of a motor vehicle by means of cameras of a vehicle-side camera system, for example a surround view camera system. The raw images or input images captured by the cameras can be displayed to a driver of the motor vehicle on a display device, for example a display in a passenger cabin of the motor vehicle. Therein, output images are also increasingly generated from the raw images of the different cameras, which represent the motor vehicle as well as the environmental region in a predetermined target view or from a predetermined target perspective. Such a predetermined target view or target perspective can be a socalled third-person view or third-person perspective, by which the environmental region of the motor vehicle as well as the motor vehicle itself is represented from a view of an observer external to vehicle, a so-called virtual camera, in the output image. Such a thirdperson view can for example be a top view. The output image generated from the raw images is therefore a top view image, also referred to as bird's eye view representation, which images a top side of the motor vehicle as well as the environmental region surrounding the motor vehicle.

For generating the output image, the raw images are projected to a target surface, for example a two-dimensional plane or a curved surface. Subsequently, the raw images are combined and rendered to the output image such that the output image seems to have been captured by the virtual camera from an arbitrarily selectable target perspective and thus has an arbitrarily selectable display area or view port. Otherwise stated, the raw images can be combined and merged to a mosaic-like output image, which finally creates the impression that it would have been captured by a single, real camera in a position of the virtual camera. With an output image in the form of a top view image, the virtual camera is for example positioned in the direction of a vehicle vertical axis directly above the motor vehicle and parallel to the motor vehicle such that the display area has an underground, for example a roadway area.

In order to therein obtain a high-quality output image, mutually corresponding image areas in the raw images having been captured by the different cameras, but having the same three-dimensional content originating from the environmental region, should have similar characteristics. For example, they should have a similar brightness, colour, resolution, sharpness and noise. If this is not the case and image areas with different sharpnesses are for example combined or merged, thus, it can occur that the combined output image has output image areas with remarkable sharpness differences and sharpness transitions. These sharpness differences decrease the image quality of the output image displayed to the driver, in particular if the motor vehicle moves, and can be annoying for the driver.

It is the object of the present invention to provide a solution, how output images showing a motor vehicle and an environmental region of the motor vehicle in a predetermined target view can be generated with high quality to display them to a driver of the motor vehicle.

According to the invention, this object is solved by a method, a camera system as well as a motor vehicle having the features according to the respective independent claims. Advantageous embodiments of the invention are the subject matter of the dependent claims, the description as well as the figures.

According to an aspect of a method for generating an output image showing a motor vehicle and an environmental region of the motor vehicle in a predetermined target view based on at least partially overlapping raw images captured by at least two vehicle-side cameras, respective camera-specific pixel density maps are in particular specified, which each describe an image-region dependent distribution of a number of pixels of the raw image captured by the associated camera contributing to the generation of the output image. The raw images can be spatially adaptively filtered based on the pixel density map specific to the associated camera, which indicates an image-region dependent extent of filtering. In particular, mutually corresponding image areas are identified in the at least partially overlapping raw images of the at least two cameras, the image area of the raw image of the one camera is spatially adaptively filtered based on the pixel density map specified to the respectively other camera for reducing a sharpness difference between the mutually corresponding image areas and the filtered raw images are remapped to an image surface corresponding to the target view for generating remapped filtered raw images. The output image can be generated by combining the remapped filtered raw images.

Particularly preferably, in a method for generating an output image showing a motor vehicle and an environmental region of the motor vehicle in a predetermined target view based on at least partially overlapping raw images captured by at least two vehicle-side cameras, respective camera-specific pixel density maps are specified, which each describe an image-region dependent distribution of a number of pixels of the raw image captured by the associated camera contributing to the generation of the output image. Based on the pixel density map specific to the associated camera, which indicates an image-region dependent extent of filtering, the raw images are spatially adaptively filtered. Moreover, mutually corresponding image areas are identified in the at least partially overlapping raw images of the at least two cameras, the image area of the raw image of the one camera is spatially adaptively filtered based on the pixel density map specific to the respectively other camera for reducing a sharpness difference between the mutually corresponding image areas and the filtered raw images are remapped to an image surface corresponding to the target view for generating remapped filtered raw images. The output image is generated by combining the remapped filtered raw images.

In other words, this means that for at least one first raw image captured by a first camera, a first pixel density map is specified, which describes the image-region dependent distribution of the number of pixels of the at least one first raw image captured by the first camera contributing to the generation of the output image. For at least one second raw image captured by a second camera different from the first camera, a second pixel density map is specified, which describes the image-region dependent distribution of the number of pixels of the at least one second raw image captured by the second camera contributing to the generation of the output image. Therein, the at least one first raw image is spatially adaptively filtered based on the first pixel density map and the at least one second raw image is spatially adaptively filtered based on the second pixel density map. Moreover, the image area in the at least one first image is filtered based on the second pixel density map and the corresponding image area in the at least one second image is filtered based on the first pixel density map.

The method serves for generating high-quality output images, which show the motor vehicle and the environmental region surrounding the motor vehicle in the predetermined target view or from a predetermined target perspective. The output images can be displayed to a driver of the motor vehicle in the form of a video sequence, in particular a real-time video, on a vehicle-side display device. The output images are generated for example by a vehicle-side image processing device based on the raw images or input images, which are captured by the at least two vehicle-side cameras. Therein, the raw images are remapped or projected to the image surface or target surface, for example a two-dimensional surface, and the remapped or projected raw images are combined for generating the output image. By means of the display of the output images on the vehicle-side display device, the driver can be assisted in manoeuvring the motor vehicle. The driver can capture the environmental region by looking to the display device. The surround view camera system and the display device constitute a camera monitor system (CMS).

In particular, the output images are generated based on at least four raw images of at least four cameras of a vehicle-side surround view camera system. Therein, the cameras are in particular disposed at different locations of attachment at the motor vehicle and thus have different perspectives or differently oriented detection ranges. Therefore, the different raw images also show different partial areas of the environmental region. For example, at least one first raw image from the environmental region in front of the motor vehicle can be captured by a front camera, at least one second image from the passenger-side environmental region can be captured by a passenger-side wing mirror camera, at least one third image from the environmental region behind the motor vehicle can be captured by a rear camera and at least one fourth image from the driver-side environmental region can be captured by a driver-side wing mirror camera. Preferably, the output image is a top view image or a bird's eye view representation of the environmental region. Thus, the predetermined target view preferably corresponds to a top view.

A pixel density map is specified for each camera, based on which the raw images of the respective camera are spatially adaptively filtered. The pixel density maps can be once determined and for example be recorded in a vehicle-side storage device for the image processing device, which can spatially adaptively filter the raw images of a camera based on the associated pixel density map. The pixel density map corresponds to a spatial distribution of pixel densities, which describes a number of the pixels or image elements of the raw images, which contribute to the generation of certain image regions within the output image. The certain image regions image certain partial areas or so-called regions of interest (ROI) in the environmental region. For example, the distribution can be determined by dividing the environmental region, e.g. a ground surface or roadway surface, into partial areas and determining a measure for each partial area. Therein, the measure describes a ratio between numbers of image elements of the raw images and the output image, which are used for representing the respective partial area in the output image. Otherwise stated, the environmental region is divided, a certain partial area in the environmental region is selected and the pixel densities are determined. Thus, it is determined how many pixels this certain partial area occupies in the raw images and output images, respectively. Thus, the pixel density map is a metric to measure the pixel ratio of the raw images to the combined output images. On the one hand, the pixel density map gives indication of an image-region dependent severity of interfering signals, for example artificial flickering effects or aliasing artefact, in the output image. On the other hand, the pixel density map gives indication of an image-region dependent subsampling or up-sampling amount or magnitude.

Due to the pixel density maps, image regions can be identified, which undergo a significant up-sampling magnitude and thus introduce blur in the output image. For determining the respective pixel density maps, the determined pixel densities can be grouped to at least two density zones based on their magnitude. In other words, the pixel densities having a values within a predetermined range of values can be assigned to a density zone. Therein, it can be provided that in particular more than five density zones or pixel density clusters are determined. Thus, a corresponding number ratio of image elements or a corresponding sub-sampling ratio can associated with each density zone. The pixel density maps can for example be determined depending on a position of the camera at the motor vehicle. Namely, the closer a partial area of the environmental region is to the camera, the greater the value of the pixel density is in the associated image region. The image regions, with which a lower pixel density is associated, usually have more spatial blurring.

In addition, the mutually corresponding image areas are determined in the raw images, which each have the same image content. Otherwise stated, the mutually corresponding image areas show the same partial area of the environmental region, but have been captured by different cameras. The cameras are in particular wide-angle cameras and have wide-angle lenses, for example fish-eye lenses. Thereby, the capturing ranges of two adjacent cameras can overlap each other in certain areas such that the cameras capture the same partial area of the environmental region in certain areas. These mutually corresponding image areas of two raw images overlap in combining the remapped raw images to the output image and are therefore both taken into account in generating the output image. The mutually corresponding image areas are therefore overlap areas. Therein, it can occur that the image areas have different sharpnesses. This can result from the fact that the partial area captured by two adjacent cameras has different distances to the cameras. Due to these overlapping image areas with different sharpness, the resulting output image would have disturbing effects in the form of a remarkable sharpness discrepancy and a non-harmonic sharpness transition to an adjacent output image area in the resulting output image area. Thereby, the image quality of the output image deteriorates.

In order to prevent this, the respective raw images are spatially adaptively filtered based on the associated pixel density map as well as based on the pixel density maps of the respective other, adjacent raw image. Due to the pixel density values within the pixel density map, those image regions with high level of blurriness can be particularly simply and fast identified and filtered accordingly. In particular, those image regions can be identified via the pixel density maps where there is no sub-sampling. Only in image regions without sub-sampling or only up-sampling it is expected that additional blur is introduced into the output image due to the remapping, i.e., a perspective projection. In those image regions, sharpening can be applied, wherein then the pixel density values of the associated camera and its neighbouring camera are used to define the amount of filtering, peaking or blurring. Thereby, different sharpnesses of the image areas can be adapted to each other and sharpness differences can be reduced.

In summary, the respective raw images are spatially adaptively filtered based on the associated and neighboured pixel density maps. The pixel density maps can guide the spatially adaptive filter to be applied. The spatially adaptive filtering can act as a spatial smoothing or blurring operation and a sharpening or peaking operation depending on the camera-associated pixel density map as well as on the pixel density map of the neighbouring camera sharing the same overlapping image areas. In particular, a spatial low-pass filtering for reducing disturbing signals and a peaking strength can be formed to be adaptive to the pixel density maps with filtering in both cases being spatially adaptive. Due to the spatially adaptive filtering of the raw images based on the pixel density maps of the associated camera and the neighbouring camera, blurred image areas can be sharpened, for example by gradient peaking. Moreover, as appropriate, an overlapping image area in one raw image can be spatially smoothed in case the corresponding overlapping image area in the other raw image cannot be sharpened enough.

The filtered raw images are then remapped to the image surface corresponding to the target view or the target surface. For remapping the raw images a geometric transform of the raw images and an interpolation of the raw image pixels are performed. Those remapped filtered raw images are then merged for generating the output image. Since the predetermined target perspective is in particular a third-person perspective, which shows the motor vehicle as well as the environmental region around the motor vehicle from the view of an observer external to vehicle, and the motor vehicle itself cannot be captured by the vehicle-side cameras, a model of the motor vehicle is inserted for generating the output image.

By considering the pixel density maps of adjacent cameras, a harmonic sharpness progress can be achieved in the resulting output image and thus a high-quality output image low in disturbing transitions of sharpness and blur within image contents showing the same partial area in the environmental region can be generated, which can be displayed to the driver of the motor vehicle on the display device.

Preferably, each one horizontal and each one vertical pixel density map is determined for each camera for indicating respective image regions of the raw images to be filtered. This means that the raw images of a camera are spatially adaptively filtered with the horizontal pixel density map and the vertical pixel density map of the associated camera. In addition, the corresponding image areas of the raw images are spatially adaptively filtered with the horizontal and vertical pixel density maps of the adjacent camera.

In a particularly preferred embodiment of the invention, a camera-specific sharpness mask is defined for each camera as a function of the pixel density map specific to the associated camera and as a function of the pixel density map specific to the respective other camera, wherein the raw images are spatially adaptively filtered as a function of the respective sharpness mask of the camera capturing the respective raw image. It may be provided that each one horizontal and each one vertical sharpness mask are determined for each camera. The horizontal sharpness masks can be determined depending on the horizontal pixel density maps specific to the associated and specific to the respective other camera. The vertical sharpness masks can be determined depending on the vertical pixel density maps specific to the associated and specific to the respective other camera.

In particular, the camera-specific sharpness masks are additionally defined as a function of at least one camera property of the associated camera. Preferably, a lens property of the respective camera and/or at least one extrinsic camera parameter of the respective camera and/or at least one intrinsic camera parameter of the respective camera is predefined as the at least one camera property. The at least one camera property can also include presettings of the camera, by which the camera already performs certain, camera-internal image processing steps.

In other words, the respective sharpness mask for a specific camera is determined based on the pixel density map of the specific camera, on the pixel density map of the neighbouring camera, and on the at least one camera property of the specific camera. For determination of the camera-specific sharpness masks, for each raw image the pixel density maps, in particular the vertical and horizontal pixel density maps, can firstly be modified in the overlapping areas based on the neighbouring camera pixel density maps. Thereafter, the obtained modified pixel density map is then combined with a camera image model, which includes the at least one camera property, for example optics and specific camera presettings that could influence the camera image sharpness and spatial discontinuity in sharpness. The sharpness masks are two-dimensional masks, by which an extent of the sharpening to be performed varying from image region to image region is predefined. Therein, a pixel is in particular associated with each element in the sharpness mask, wherein the element in the sharpness mask specifies to which extent the associated pixel is filtered. By means of the sharpness masks, camera properties influencing the quality of the output image can be taken into account that cannot be considered by means of the pixel density map itself.

Particularly preferably, for each camera a camera-specific, spatially adaptive filter scheme for spatially adaptively filtering the respective raw image is determined in dependence on the camera-specific sharpness mask. Thus, an adaptive filtering scheme is determined for each camera, which is dependent on the camera-specific pixel density map, the pixel density map of the adjacent camera(s) as well as the camera-related properties, i.e. on the camera-specific sharpness mask. High-quality output images can be produced in this way.

In a development of the invention, for spatially adaptive filtering of the corresponding image areas in the at least two, partially overlapping raw images, an image content of the image area in a first one of the raw images is sharpened by means of the filter scheme specific to the camera capturing the first raw image, and an image content of the corresponding image area in a second one of the raw images is blurred or not filtered by means of the filter scheme specific to the camera capturing the second raw image. In particular, based on the camera-specific sharpness masks, this raw image is identified as the first raw image to be sharpened, whose image area has a lower sharpness compared with the image area of the other, second raw image. This development is based on the realisation that the image areas have a certain sharpness discrepancy depending on how far the associated partial area of the environmental region is away from the camera. Now, in order to prevent an image quality of the resulting output image area from being decreased by this sharpness discrepancy, this sharpness discrepancy is reduced before generating the output image. Otherwise stated, the sharpnesses of the image areas of the different raw images are harmonized. Thereto, a sharpness of the respective image areas with the same image content, thus a sharpness of the overlap areas, can first be determined. Therein, the image area in the one raw image, in which the image area has a low first sharpness, is sharpened and in the other raw image, in which the image area has a second sharpness higher compared to the first sharpness, is blurred or not filtered at all. Therein, the determination of the filter schemes and thereby the determination of a degree of the sharpness adaptation is in particular effected depending on the sharpness discrepancy, which can be determined based on the camera-specific sharpness masks.

It proves advantageous if the camera-specific, spatially adaptive filter scheme is determined based on a multi-scale and multi-orientation gradient approach. Therein, it can be provided that filter nature and strengths for the filter schemes for filtering the mutually corresponding image areas are separately determined for each pixel in the respective image area. Using a multi-resolution gradient approach, in the image area of the raw images to be sharpened, the gradients can be peaked or enhanced and in the image area to be blurred, the gradients can be smoothed. Therein, the filtering scheme is determined for each pixel position, corresponding gradient magnitude and each camera image within the overlap area to achieve the optimum degree of the sharpness adaptation in the overlap areas.

In a development of the invention, the spatially adaptive filter scheme is modified based on a non-decimated wavelet transformation, wherein wavelet coefficients are adaptively modified based on the camera-specific sharpness mask. In particular, the wavelet coefficients are adaptively modified based on a transfer-tone-mapping function, which is applied based on the camera-specific sharpness mask. Thus, a wavelet-based filtering of the raw images is performed. In the simplest case the tone-mapping function or curve can have a fixed shape and is applied based on the sharpness masks. Advantageously, the tone-mapping curve is of different shape for each wavelet band and can be reshaped based on the corresponding sharpness mask.

Within the multiscale approach based on the wavelet transformation, the raw image is in particular first decomposed into multi-resolution representations, wherein in each resolution level, the raw image is further decomposed in different gradient orientation bands. The wavelet coefficients are determined adaptively based on the transfer tone mapping function or dynamic compression function, which in turn is adapted as a function of the camera-specific sharpness mask. Finally, after applying the tone-mapping function on wavelet coefficients, the inverse wavelet transform is applied to obtain the filtered raw image, based on which a part of the target view can be generated.

It proves to be advantageous, if, for determining the camera-specific, spatially adaptive filter scheme, at least two camera-specific sharpness masks are defined for at least two wavelet bands of the wavelet transform as a function of the pixel density map specific to the associated camera and as a function of the pixel density map specific to the respective other camera. For example, horizontal sharpness masks can be determined based on horizontal pixel density maps which can be used for horizontally oriented wavelet bands, and vertical sharpness masks can be determined based on vertical pixel density maps which can be used for vertically oriented wavelet bands.

In an embodiment of the invention, the at least one sharpness mask is combined with spatially neighbouring area statistics in wavelet bands. The statistics concern correlation of the wavelet coefficients in spatially neighbouring areas in each wavelet band separately. Additionally, inter-scale correlation of the wavelet coefficients within the same orientation in order to determine a cone of influence can be used. This cone of influence provides information how the wavelet coefficients in each orientation progress through the scales. For example, a spatial neighbouring position in the raw camera image is considered to contain significant feature if the progression of the corresponding wavelet coefficients within this neighbourhood expands through many resolution scales. Thus, the progression can be used for either estimating an absolute sharpness or estimating a place where sharpness enhancement will make a most difference in terms of visual quality. The more scales the wavelet coefficients extend the more significant feature it is. Then it proves to be advantageous if the sharpness mask is applied in full extent or the highest level of sharpness parameters are used. Conversely, a small progression corresponds to an area comprising some noise that should not be amplified. These spatially neighbouring area statistics combined with sharpness masks facilitate higher level of adaptiveness of the applied sharpness mask to spatially local wavelet coefficient neighbourhoods and such provide more accurate wavelet processing scheme.

The invention additionally relates to a camera system for a motor vehicle comprising at least two cameras for capturing raw images from an environmental region of the motor vehicle and an image processing device, which is adapted to perform a method according to the invention or an embodiment thereof. The camera system is in particular formed as a surround view camera system, which comprises a front camera for capturing the environmental region in front of the motor vehicle, a rear camera for capturing the environmental region behind the motor vehicle and two wing mirror cameras for capturing the environmental region next to the motor vehicle. The image processing device can for example be integrated in a vehicle-side controller and is formed to generate the output image based on the raw images or input images of the surround view camera system.

A motor vehicle according to the invention includes a camera system according to the invention. The motor vehicle is in particular formed as a passenger car. Therein, the cameras are in particular disposed distributed at the motor vehicle such that the environmental region around the motor vehicle can be monitored. In addition, the motor vehicle can comprise a display device for displaying the output image, which is for example disposed in a passenger cabin of the motor vehicle.

The preferred embodiments presented with respect to the method according to the invention and the advantages thereof correspondingly apply to the camera system according to the invention as well as to the motor vehicle according to the invention.

With indications of “in front of”, “behind”, “next to”, “above”, “left”, “right”, “lateral” etc., the positions and orientations given with an observer standing in front of the motor vehicle and looking in a direction of a longitudinal axis of the motor vehicle are specified.

Further features of the invention are apparent from the claims, the figures and the description of figures. The features and feature combinations mentioned above in the description as well as the features and feature combinations mentioned below in the description of figures and/or shown in the figures alone are usable not only in the respectively specified combination, but also in other combinations or alone without departing from the scope of the invention. Thus, implementations are also to be considered as encompassed and disclosed by the invention, which are not explicitly shown in the figures and explained, but arise from and can be generated by separated feature combinations from the explained implementations. Implementations and feature combinations are also to be considered as disclosed, which thus do not have all of the features of an originally formulated independent claim. Moreover, implementations and feature combinations are to be considered as disclosed, in particular by the implementations set out above, which extend beyond or deviate from the feature combinations set out in the relations of the claims.

There show:

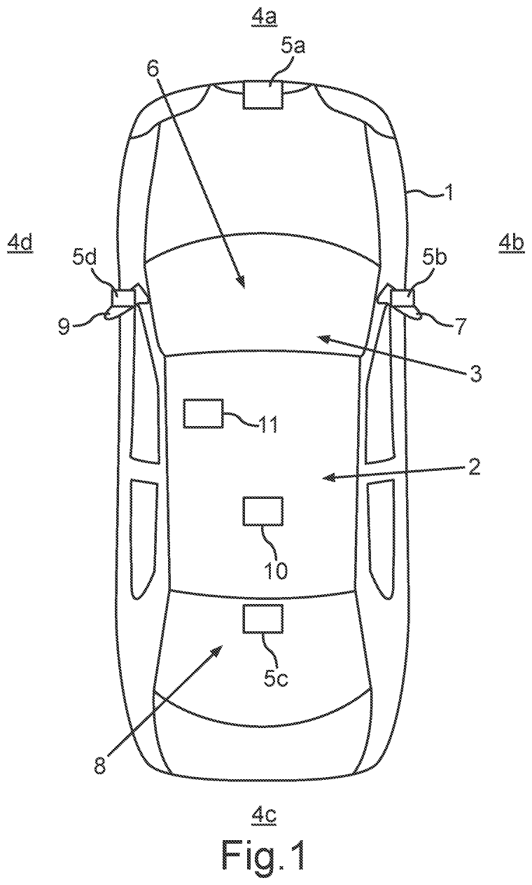

FIG. 1 a schematic representation of an embodiment of a motor vehicle according to the invention;

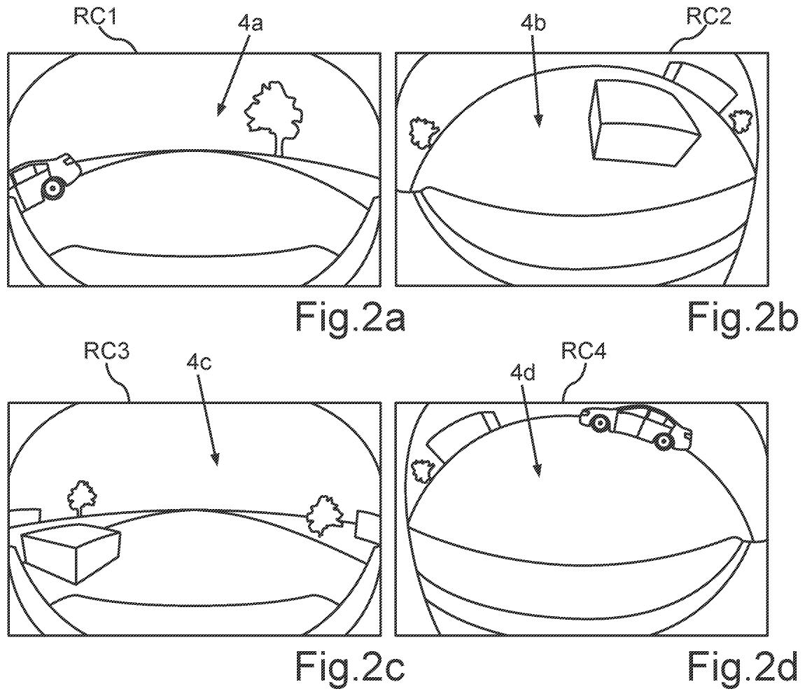

FIGS. 2a to 2d schematic representations of four raw images captured by four cameras of the motor vehicle from an environmental region of the motor vehicle;

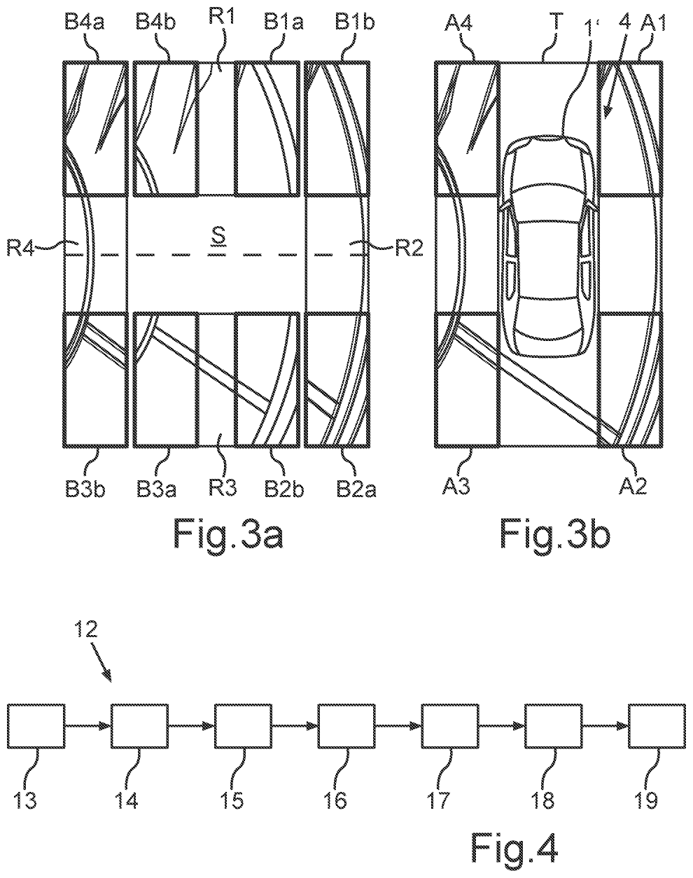

FIG. 3a a schematic representation of remapped raw images from an environmental region of the motor vehicle;

FIG. 3b a schematic representation of a top view image generated from the remapped raw images;

FIG. 4 a schematic representation of an embodiment of a method course according to the invention;

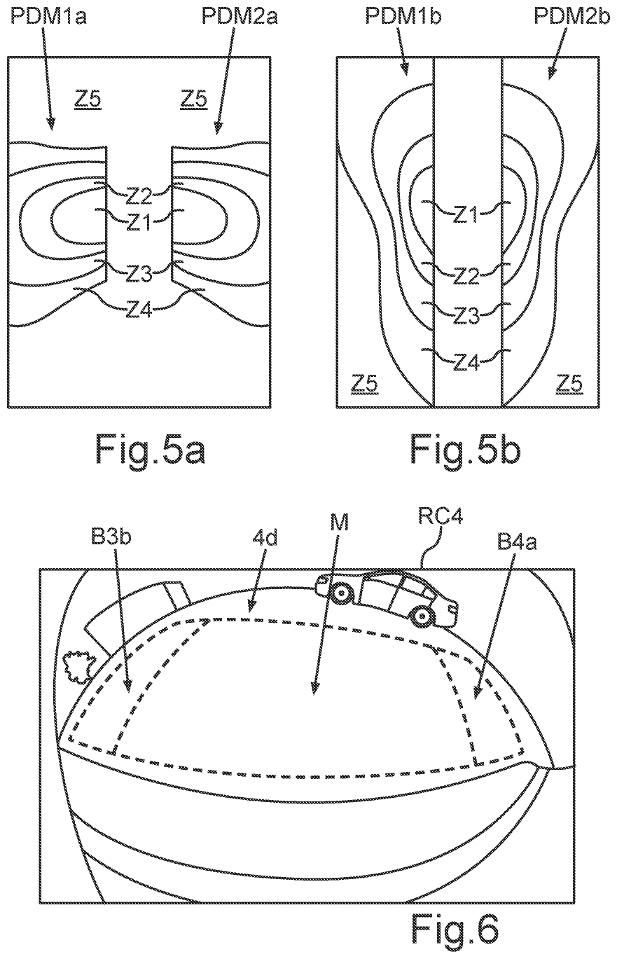

FIG. 5a, 5b schematic representations of horizontal and vertical pixel density maps of wing mirror cameras of the motor vehicle; and

FIG. 6 a schematic representation of a raw image of a wing mirror camera.

In the figures identical as well as functionally identical elements are provided with the same reference characters.

FIG. 1 shows a motor vehicle 1, which is formed as a passenger car in the present case. Here, the motor vehicle 1 has a driver assistance system 2, which can assist a driver of the motor vehicle 1 in driving the motor vehicle 1. The driver assistance system 2 has a surround view camera system 3 for monitoring an environmental region 4a, 4b, 4c, 4d of the motor vehicle 1. Presently, the camera system 3 comprises four cameras 5a, 5b, 5c, 5d disposed at the motor vehicle 1. A first camera 5a is formed as a front camera and disposed in a front area 6 of the motor vehicle 1. The front camera 5a is adapted to capture first raw images RC1 (see FIG. 2a) from the environmental region 4a in front of the motor vehicle 1. A second camera 5b is formed as a right wing mirror camera and disposed at or instead of a right wing mirror 7 at the motor vehicle 1. The right wing mirror camera 5b is adapted to capture second raw images RC2 (see FIG. 2b) from the environmental region 4b to the right next to the motor vehicle 1. A third camera 5c is formed as a rear camera and disposed in a rear area 8 of the motor vehicle 1. The rear camera 5c is adapted to capture third raw images RC3 (see FIG. 2c) from the environmental region 4c behind the motor vehicle 1. A fourth camera 5d is formed as a left wing mirror camera and disposed at or instead of a left wing mirror 9 at the motor vehicle 1. The left wing mirror camera 5d is adapted to capture fourth raw images RC4 (see FIG. 2d, FIG. 6) from the environmental region 4d to the left next to the motor vehicle 1. Therein, the raw images RC1, RC2, RC3, RC4 shown in FIG. 2a, 2b, 2c, 2d are projected or remapped to a target surface S, for example a two-dimensional plane in order to generate remapped raw images R1, R2, R3, R4 as shown in FIG. 3a.

In addition, the camera system 3 has an image processing device 10, which is adapted to process the raw images RC1, RC2, RC3, RC4 and to generate an output image from the raw images RC1, RC2, RC3, RC4 by combining the remapped raw images R1, R2, R3, R4. The output image represents the motor vehicle 1 and the environmental region 4 surrounding the motor vehicle 1 in a predetermined target view. Such a target view can be a top view such that a top view image can be generated as the output image, which shows the motor vehicle 1 as well as the environmental region 4 from the view of an observer or a virtual camera above the motor vehicle 1. This output image can be displayed on a vehicle-side display device 11. The camera system 3 and the display device 11 thus form a driver assistance system 2 in the form of a camera monitor system which supports the driver by displaying the environmental area 4 of the motor vehicle 1 on the display device 11 in any desired target view, which is freely selectable by the driver.

Therein, the raw images RC1, RC2, RC3, RC4 as well as the remapped raw images R1, R2, R3, R4 of two adjacent cameras 5a, 5b, 5c, 5d have mutually corresponding image areas B1a and B1b, B2a and B2b, B3a and B3b, B4a and B4b. For example, the image area B1a is located in the first remapped raw image R1, which has been captured by the front camera 5a. The image area B1b corresponding to the image area B1a is located in the second remapped raw image R2, which has been captured by the right wing mirror camera 5b. The image area B2a is located in the second remapped raw image R2 which has been detected by the right wing mirror camera 5b and the corresponding image area B2b is located in the third remapped raw image R3 which has been captured by the rear camera 5c, etc. This means that the mutually corresponding image areas B1a and B1b, B2a and B2b, B3a and B3b, B4a and B4b each have the same image content. This results from at least partially overlapping capturing ranges of two adjacent cameras 5a, 5b, 5c, 5d.

In particular, within the raw images RC2, RC4 and the remapped raw images R2, R4 of the wing mirror cameras 5b, 5d, the image areas B1b, B2a, B3b, B4a are blurred because the image content of these image areas B1b, B2a, B3b, B4a here originates from an edge area of the detection ranges of the cameras 5b, 5d and is also distorted by wide-angle lenses of the cameras 5b, 5d. If these blurred image areas B1b, B2a, B3b, B4a are now combined with the corresponding, but clearly sharper image areas B1a, B2b, B3a, B4b for generating the output image, clearly visible sharpness discrepancies and erratic sharpness transitions appear in the generated output image. In FIG. 3b, an output image in the form of a top view image T is exemplarily shown. The top view image T is generated from the remapped raw images R1, R2, R3, R4, whereby a model 1′ of the motor vehicle 1 is inserted since the motor vehicle 1 itself cannot be detected by the cameras 5a, 5b, 5c, 5d. Due to the combination of the differently sharp corresponding image areas B1a and B1b, B2a and B2b, B3a and B3b, B4a and B4b, the top view image T comprises respective image areas A1, A2, A3, A4 having a sharpening discrepancy. The top view image T shown in FIG. 3b therefore has a reduced image quality in the form of the noticeable sharpness transition within the top view image T.

In order to at least weaken this clearly visible sharpness transition and thus to increase the image quality of the output images, the image processing device 10 of the camera system 3 is designed to perform a method which is shown schematically with reference to a flow chart 12 in FIG. 4. By means of the method, a sharpness harmonization can be achieved in the resulting output image by spatially adaptively filtering the raw images RC1, RC2, RC3, RC4 to be projected onto the target surface S and by interpolating the projected filtered raw images R1, R2, R3, R4 to the output image.

For this purpose, in a first step 13, a camera-specific pixel density map is prescribed for each camera 5a to 5d. The respective camera-specific pixel density map represents a ratio of a distance between the two neighbouring pixel positions in the raw images RC1, RC2, RC3, RC4 or the corresponding remapped raw images R1, R2, R3, R4 to be used in the output image with the target view. Since in the target view the distance has a certain reference value, then the pixel density map is computed based on the distance of the corresponding neighbouring pixels in the raw image RC1, RC2, RC3, RC4 that are used to generate a pixel in the output image with the target view at that particular position. Dependent on the reference value this corresponds to a spatially variable sub-sampling or up-sampling. In case of horizontal pixel density the distance is a horizontal neighbour distance in horizontal direction, and in case of vertical pixel density the distance is a vertical neighbour distance in vertical direction. By means of the pixel density maps, positions of respective image regions or regions of interest (ROI) of the raw images R1 to R4 to which a filter is to be applied as well as an extent of the filter to be applied to these image regions can be specified.

Here, in particular, a horizontal pixel density map and a vertical pixel density map as the pixel density map is determined for each camera 5a to 5d. FIG. 5a shows horizontal pixel density maps PDM1a, PDM2a for spatially adaptive filtering in the horizontal image direction, wherein a first horizontal pixel density map PDM1a is assigned to the left wing mirror camera 5d and a second horizontal pixel density map PDM2a is assigned to the right wing mirror camera 5b. FIG. 5b shows vertical pixel density maps PDM1b, PDM2b for spatially adaptive filtering in the vertical image direction, wherein a first vertical pixel density map PDM1b is assigned to the left wing mirror camera 5d and a second vertical pixel density map PDM2b is assigned to the right wing mirror camera 5b. The pixel density maps for the front camera 5a and the rear camera 5b are not shown here for the sake of clarity.

The pixel densities are here grouped or clustered in density zones Z1, Z2, Z3, Z4, Z5 in the respective pixel density map PDM1a, PDM2a, PDM1b, PDM2b based on a magnitude of their values. Thus, each density zone Z1, Z2, Z3, Z4, Z5 is assigned to certain corresponding number ratios of pixels or corresponding subsampling ratios. Here, in the first density zone Z1, pixel densities with the highest values are grouped, wherein the density values gradually decrease in the direction of the fifth density zone Z5. Thus, in the fifth density zone Z5, pixel densities with the lowest values are grouped. The density zones Z1, Z2, Z3, Z4, Z5 can be used to specify a severity of disturbing effects, so-called aliasing artefacts, in the raw images RC1, RC2, RC3, RC4 depending on the image region, which can occur in the raw images RC1, RC2, RC3, RC4 due to the high degree of texture subsampling, for example upon a gravelly road surface. The higher a pixel density is, the stronger are the disturbing effects in the image regions in the raw images RC1, RC2, RC3, RC4 belonging to the density zones Z1, Z2, Z3, Z4, Z5.

In a second step 14, the image areas B1a and B1b, B2a and B2b, B3a and B3b, B4a and B4b corresponding to each other are identified in order to eliminate the problem of the sharpening discrepancy in the output image due to the differently sharp corresponding overlapping areas or image areas B1a and B1b, B2a and B2b, B3a and B3b, B4a and B4b. In a third step 15, camera-specific sharpness masks are determined for each camera 5a, 5b, 5c, 5d. The sharpness masks are determined as a function of the respective camera-specific pixel density maps, of which only the pixel density maps PDM1a, PDM2a, PDM1b, PDM2b are shown here, as well as on the pixel density maps of the neighbouring cameras 5a, 5b, 5c, 5d. For example, the sharpness mask, in particular a horizontal and a vertical sharpness mask, of the front camera 5a is determined based on the pixel density map of the front camera 5a, the pixel density map PDM2a, PDM2b of the right wing mirror camera 5b and the pixel density map PDM1a, PDM1b of the left wing mirror camera 5d. The sharpness mask, in particular a horizontal and a vertical sharpness mask, of the right wing mirror camera 5b is determined based on the pixel density map PDM2a, PDM2b of the right wing mirror camera 5b, the pixel density map of the front camera 5a and the pixel density map of the rear camera 5c, etc. Moreover, the camera specific sharpness masks are determined based on at least one camera property, for example a camera lens model, an image sensor of the camera 5a, 5b, 5c, 5d, camera settings, as well as image positions of the image regions of interest of the respective camera 5a, 5b, 5c, 5d. Each camera image RC1, RC2, RC3, RC4 is thus considered independently by taking into account the camera characteristics of the camera 5a, 5b, 5c, 5d detecting the respective raw image RC1, RC2, RC3, RC4 by means of the camera specific sharpness mask. By means of the sharpness masks, deformations in the raw images RC1, RC2, RC3, RC4, which are caused, for example, by wide-angle lenses of the cameras 5a, 5b, 5c, 5d, can be modelled pixel by pixel.

On the basis of the raw image RC4 of the left-hand wing mirror camera 5d shown in FIG. 6 it is visualized that the raw image RC4 is sharpest in an image centre M and is the more blurred the further an image region, for example the image areas B3b, B4a, is. This distortion results here, for example, from the wide-angle lens in the form of a fish-eye lens of the left-hand wing mirror camera 5d. The camera-specific sharpness mask which maps or describes such a degradation in the raw image RC4 is used in a fourth step 16 to determine a filter scheme for the raw images RC1, RC2, RC3, RC4 for the spatially adaptive filtering. The filter scheme is, in particular, a spatially adaptive filter scheme, which is based on a multi-scale and multi-oriented gradient approach, such as wavelets. In particular, a non-decimated wavelet transform can be used in which wavelet coefficients are adaptively modified with a specifically designed transfer-tone-mapping function. The transfer-tone-mapping function can be tuned based on the camera-specific sharpness masks.

In a fifth step 17, the raw images RC1, RC2, RC3, RC4 are spatially adaptively filtered based on the sharpness mask of the respective camera 5a, 5b, 5c, 5d using the determined filter scheme. Thereby, each raw image RC1, RC2, RC3, RC4 is, in particular horizontally and vertically, filtered on the basis of the sharpness mask of the associated camera 5a, 5b, 5c, 5d. The raw image RC1 of the front camera 5a is filtered based on the sharpness mask of the front camera 5a, the raw image RC2 of the right wing mirror camera 5b is filtered based on the sharpness mask of the right wing mirror camera 5b, the raw image RC3 of the rear camera 5c is filtered based on the sharpness mask of the rear camera 5c and the raw image RC4 of the left wing mirror camera 5d is filtered based on the sharpness mask of the left wing mirror camera 5d. In particular, the sharpness masks serve as guidance images, which can, for example, spatially limit a filter strength of a filter, for example a low-pass filter or a gradient peaking. The higher, for example, the value of the pixel density, the higher a low-pass filter strength can be selected in order to reduce the disturbing effects, which can occur, for example, as flicker effects in the raw images RC1, RC2, RC3, RC4. The filtering, which takes place depending on the camera specific or raw-image-specific sharpness masks and thus on the image-region-dependent severity of the disturbing signals in the raw images RC1, RC2, RC3, RC4, prevents a raw image RC1, RC2, RC3, RC4 is filtered in an unnecessarily strong or in a too weak manner in certain image regions.

By means of the double filtering in the corresponding image areas or overlapping areas B1a and B1b, B2a and B2b, B3a and B3b, B4a and B4b, softer sharpness transitions can be obtained from one raw image RC1, RC2, RC3, RC4 to another raw image RC1, RC2, RC3, RC4 within the output image. Thereby, a reduced filter strength for image areas B1b, B2a, B3b, B4a of those raw images RC2, RC4 in which the image areas B1b, B2a, B3b, B4a are less sharp than the corresponding image areas B1a, B2b, B3a, B4b of the respectively adjacent raw images RC1, RC3 can be provided by means of the respective sharpness masks. For example, the image areas B1b, B2a, B3b, B4a are detected by the wing mirror cameras 5b, 5d and are thereby subjected to a larger distortion than the image areas B1a, B2b, B3a, B4b detected by the front camera 5a and the rear camera 5c. By reducing the filter strength in the blurred, fuzzy image areas B1b, B2a, B3b, B4a, these are sharpened. This is also referred to as “up-sampling”. Conversely, the sharper image areas B1a, B2b, B3a, B4b are blurred by increasing a filter strength for these image areas B1a, B2b, B3a, B4b. This is also referred to as “down-sampling”. The respective pixel density maps PDM1a, PDM1b, PDM2a, PDM2b thus serve both for “upsampling” and for “down-sampling”. This prevents a raw image RC1, RC2, RC3, RC4 from being subjected to only strong or only weak filtering.

In a sixth step 18, the filtered raw images RC1, RC2, RC3, RC4 are then remapped to the image surface S in order to generate the remapped filtered raw images R1, R2, R3, R4. In a seventh step 19, those remapped filtered raw images R1, R2, R3, R4 are merged to the output image which shows the motor vehicle 1 and the environmental region 4 in the predetermined target view, for example the top view.

In summary, pixel density maps, in particular respective vertical and horizontal pixel density maps PDM1a, PDM1b, PDM2a, PDM2b, can be individually determined for each camera 5a, 5b, 5c, 5d and the pixel density maps PDM1a, PDM1b, PDM2a, PDM2b can be adjusted as a function of adjacent pixel density maps PDM1a, PDM1b, PDM2a, PDM2b. Based on this, a two-dimensional spatial sharpness mask can be determined for each camera 5a, 5b, 5c, 5d as a function of camera settings and a lens mounting of the respective camera 5a, 5b, 5c, 5d, and a specific filter scheme for spatially adaptive filtering can be determined for each camera 5a, 5b, 5c as a function of the pixel density maps PDM1a, PDM1b, PDM2a, PDM2b and the sharpness masks. This allows an output image to be determined with a harmonic sharpness and thus with a high image quality.

1. A method for generating an output image with a predefined target view showing a motor vehicle and an environmental region of the motor vehicle based on at least partially overlapping raw images captured by at least two vehicle-side cameras, the method comprising:
specifying respective camera-specific pixel density maps, which each describe an image-region dependent distribution of a number of pixels of the raw image captured by the associated camera contributing for the generation of the output image;
spatially adaptive filtering of the raw images based on the pixel density map specific to the associated camera, which indicates an image region-dependent extent of the filtering;
identifying mutually corresponding image areas in the at least partially overlapping raw images of the at least two cameras;
spatially adaptive filtering of the image area of the raw image of the one camera based on the pixel density map specific to the respective other camera for reducing a sharpness difference between the corresponding image areas;
remapping the filtered raw images to an image surface corresponding to the target view for generating remapped filtered raw images; and
generating the output image by combining the remapped filtered raw images.

2. The method according to claim 1, wherein for each camera a horizontal and a vertical pixel density map is determined for indicating respective image regions of the raw images to be filtered.

3. The method according to claim 1, wherein for each camera, a camera-specific sharpness mask is defined as a function of the pixel density map specific to the associated camera and as a function of the pixel density map specific to the respective other camera, wherein the raw images are spatially adaptively filtered as a function of the respective sharpness mask of the camera capturing the respective raw image.

4. The method according to claim 3, wherein the camera-specific sharpness masks are additionally defined as a function of at least one camera property of the associated camera.

5. The method according to claim 4, wherein as the at least one camera property, a lens property of the respective camera and/or at least one extrinsic camera parameter of the respective camera and/or at least one intrinsic camera parameter of the respective camera is predefined.

6. The method according to claim 3, wherein for each camera, a camera-specific, spatially adaptive filter scheme for spatially adaptively filtering the respective raw image is determined in dependence on the associated camera-specific sharpness mask.

7. The method according to claim 6, wherein for spatially adaptive filtering of the corresponding image areas in the at least two, at least partially overlapping raw images, an image content of the image area in a first of the raw images is sharpened by means of the filter scheme specific to the camera capturing the first raw image, and an image content of the corresponding image area in a second of the raw images is blurred or not filtered by means of the filter scheme specific to the camera capturing the second raw image.

8. The method according to claim 6, wherein the camera-specific, spatially adaptive filter scheme is determined based on a multiscale and multi-orientation gradient approach.

9. The method according to claim 8, wherein the spatially adaptive filter scheme is determined based on a non-decimated wavelet transform, wherein wavelet coefficients are spatially adaptively modified based on the camera-specific sharpness mask.

10. The method according to claim 9, wherein the wavelet coefficients are adaptively modified based on a transfer-tone-mapping function, which is aligned on the camera-specific sharpness mask.

11. The method according to claim 9, wherein for determining the camera-specific, spatially adaptive filter scheme, at least two camera-specific sharpness masks are defined for at least two wavelet bands of the wavelet transform as a function of the pixel density map specific to the associated camera and as a function of the pixel density map specific to the respective other camera.

12. The method according to claim 9, wherein the at least one sharpness mask is combined with spatially neighbouring area statistics in wavelet bands, wherein the statistics describes a correlation of the wavelet coefficients in spatially neighbouring areas in each wavelet band separately.

13. A camera system for a motor vehicle, comprising:
at least two cameras for capturing at least partially overlapping raw images from an environmental region of the motor vehicle; and
an image processing device configured to generate an output image with a predefined target view showing the motor vehicle and an environmental region of the motor vehicle based on the at least partially overlapping raw images by:
specifying respective camera-specific pixel density maps, which each describe an image-region dependent distribution of a number of pixels of the raw image captured by the associated camera contributing for the generation of the output image,
spatially adaptive filtering of the raw images based on the pixel density map specific to the associated camera, which indicates an image region-dependent extent of the filtering,
identifying mutually corresponding image areas in the at least partially overlapping raw images of the at least two cameras,
spatially adaptive filtering of the image area of the raw image of the one camera based on the pixel density map specific to the respective other camera for reducing a sharpness difference between the corresponding image areas,
remapping the filtered raw images to an image surface corresponding to the target view for generating remapped filtered raw images, and
generating the output image by combining the remapped filtered raw images.

14. A motor vehicle comprising a camera system according to claim 13.
